(19) United States
(12) Patent Application Publication
(10) Pub. No.: US 2006/0095361 A1
(43) Pub. Date: May 4, 2006

(54) Methods and apparatus for automatic settlement of foreign securities trades in trader's operating currency

(76) Inventor: Michael G. Rude, New York, NY (US)

Correspondence Address: BUCKLEY, MASCHOFF, TALWALKAR LLC, 5 ELM STREET, NEW CANAAN, CT, 06840, US

(21) Appl. No.: 10/976,718

(22) Filed: Oct. 29, 2004

(51) Int. Cl. G06Q 40/00

(52) U.S. Cl. 705/37

(57) ABSTRACT

A method includes placing a securities trading order on a securities exchange and determining a net settlement amount for the securities trading order in the local currency of the securities exchange. In response to the determined net settlement amount, a foreign exchange trading order is automatically placed to convert the determined net settlement amount from the local currency to the operating currency of the party for whom the securities trading order was placed.

### FIELD

The present invention relates to systems, methods, apparatus, computer program code and means for electronic trading of securities, and is more particularly concerned with facilitating trading of securities priced in currencies other than a trader's operating currency.

### BACKGROUND

A great deal of securities trading takes place across national borders. For example, it is commonplace for U.S. trading operations to trade in securities traded in European stock exchanges. At the same time, many European traders trade in securities on U.S. exchanges. Such activities are somewhat complicated by the fact that a trader's operating currency (i.e., the currency of the trader's home country in which the trader pays expenses, reports income, etc.) may be different from the local currency in which a security is quoted on an exchange. Of course, the local currency is also the currency in which transactions on the exchange are settled.

The present inventor has recognized that it would be desirable to provide a securities trading system which essentially makes trading in a foreign security transparent in terms of the trader's operating currency.

### SUMMARY

To alleviate problems inherent in the prior art, embodiments of the present invention introduce systems, methods, apparatus, computer program code and means for executing securities trading transactions. According to some embodiments, a securities trading order is placed on a securities exchange. A net settlement amount for the securities trading order is determined in a local currency of the securities exchange. In response to the determined net settlement amount, a foreign exchange trading order is automatically placed to convert the determined net settlement amount from the local currency to an operating currency of a party for whom the securities trading order was placed.

In another aspect, systems, methods, apparatus, computer program code and means are provided for operating a securities trading system. The system includes a user interface. The user interface includes a display unit. Initial input is received from a user to direct the securities trading system to place on a securities exchange a securities trading order for purchase or sale of a security. In response to the initial input, the securities trading order is placed on the securities exchange. A net settlement amount is determined for the securities trading order in a local currency of the securities exchange. In response to the determined net settlement amount and without any user input after the initial input, a foreign exchange trading order is automatically placed to convert the determined net settlement amount from the local currency to an operating currency of a party for whom the securities trading order is placed.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram of a system consistent with the present invention;

FIG. 2 is a block diagram of one embodiment of an order processing server for use in conjunction with the system of FIG. 1;

FIG. 3 is a block diagram of one embodiment of a user device for use in conjunction with the system of FIG. 1;

FIG. 4 is a flow diagram illustrating an exemplary process for handling a foreign securities trading transaction pursuant to one embodiment of the present invention;

FIG. 5 is a flow diagram that shows details of one step of the process of FIG. 4;

FIG. 6 is a table showing an example of price quotations for a security in the local currency of a foreign securities exchange; and

FIG. 7 is a table showing the price quotations of FIG. 6 converted to an operating currency of a trader.

### DETAILED DESCRIPTION

Applicant has recognized that there is a need for an improved system, method, apparatus, computer program code, and means for handling foreign securities trading transactions. More particularly, Applicant has recognized that there is a need for an improved system, method, apparatus, computer program code and means for seamlessly settling foreign security trading transactions in the operating currency of the trader.

For the purposes of describing features of embodiments of the present invention, a number of terms are used herein. For example, the term “security” is used to refer to common stocks, preferred stocks, other equity instruments, bonds, notes and options.

As used herein, the term “securities exchange” is used to refer to any market which lists and facilitates the trading of securities.

As used herein, a “foreign exchange” transaction is one in which one currency is traded for another currency.

As used herein, “processor” includes two or more processors operating together, including processors in interconnected devices.

In general, and for the purposes of introducing concepts of embodiments of the present invention, foreign securities trading transactions may be processed as follows. Price quotations from a foreign securities exchange may be automatically converted to a trader's operating currency and may be displayed by a trading system to the trader in the operating currency, rather than in the local currency in which the quotations are presented on the foreign securities exchange. When an order for a foreign securities trading transaction is placed by the trader, the order is sent by the trading system to the foreign securities exchange and is executed on the foreign securities exchange in the local currency of the foreign securities exchange. Based on the execution of the order, a net settlement amount is established for the transaction, reflecting the execution price and expenses such as settlement fees and commissions. Once the settlement amount is determined, the trading system automatically executes a foreign exchange transaction in which the local currency of the foreign securities exchange is bought or sold (depending on whether the underlying securities trading transaction is a purchase or a sale) to convert the net settlement amount to the operating currency of the trader. The foreign exchange transaction may be a forward transaction effective as of the settlement date for the underlying foreign securities trading transaction to substantially eliminate all foreign exchange risk to the trader in connection with the underlying foreign securities trading transaction.

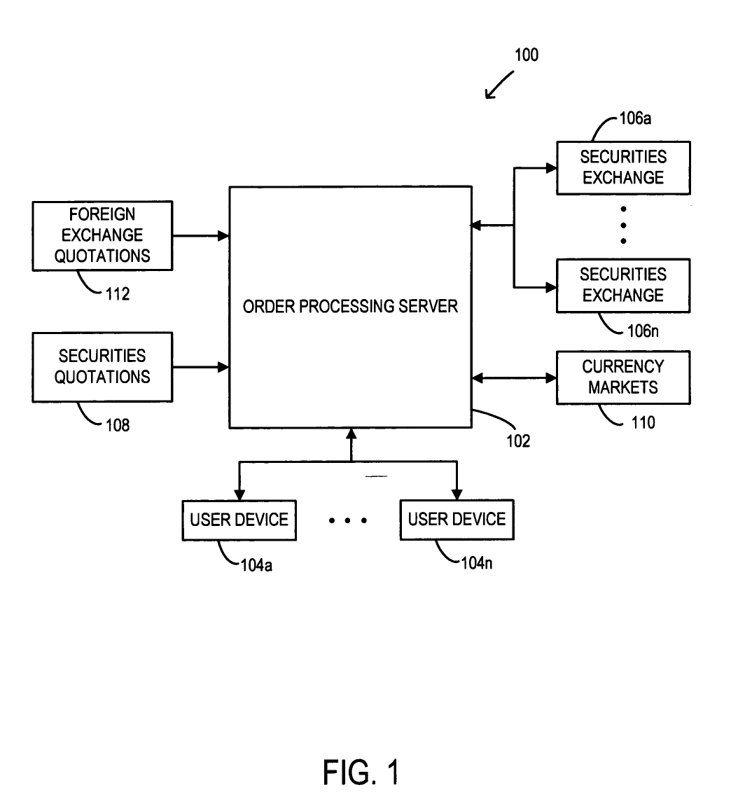

Embodiments of the present invention will now be described by first referring to FIG. 1 where a block diagram of one embodiment of a trading system 100 is shown. As shown, trading system 100 includes a number of different components which cooperatively operate to process foreign securities trading orders and related foreign exchange transactions pursuant to some embodiments of the present invention.

As depicted, trading system 100 includes an order processing server 102 in communication with one or more user device(s) 104, a plurality of securities exchanges 106, and a source or sources 108 of current securities price quotations. Some or all of the sources 108 of price quotations may, but need not, be integrated with the securities exchanges 106. The order processing server 102 is also in communication with one or more currency (foreign exchange) markets 110, and one or more sources 112 of foreign exchange price quotations. Some or all of the sources 112 of foreign exchange price quotations may be integrated with the currency markets 110.

Order processing server 102 may function as a host computer for the user devices 104 and may operate to receive and execute securities and foreign exchange trading orders on behalf of users of the user devices 104. In some embodiments, order processing server 102 may function to timestamp orders when received and to assign an order identifier or sequence number to each order. When the order inherently or explicitly indicates a securities exchange on which the order is to be executed, the order processing server 102 may route the order accordingly. In other cases, rules programmed into the order processing server 102 may cause the server to select a securities exchange to which the order is to be routed.

The order processing server 102 also operates to receive from the price quotation sources 108, 112 data concerning market conditions. Such data may include, for example, information concerning the current status of order books at the securities exchanges 106. Thus the data supplied by the source(s) 108 may include current price quotations for securities to be traded via the trading system 100. The quotations may be provided in the local currencies of the various securities exchanges, which may operate in local currencies such as pounds sterling or euros, which may be different from operating currencies such as U.S. dollars for at least some of the users of the user devices 104. In addition, the market data may include current and/or forward exchange rates for various pairs of currencies. (Some of the securities exchanges 106 may operate in the same currency as the user's operating currency. For example, some securities exchanges, such as the New York Stock Exchange, may have U.S. dollars as their local currency. By the same token, some users may operate in currencies other than U.S. dollars.)

Although a single order processing server 102 is shown in FIG. 1, any number of these devices may be included in trading system 100. Similarly, any number of securities quotation sources 108, user devices 104, exchange devices 106, foreign exchange quotation sources 112, currency markets 110 or any other device described herein may be included in the trading system 100 according to some embodiments of the present invention.

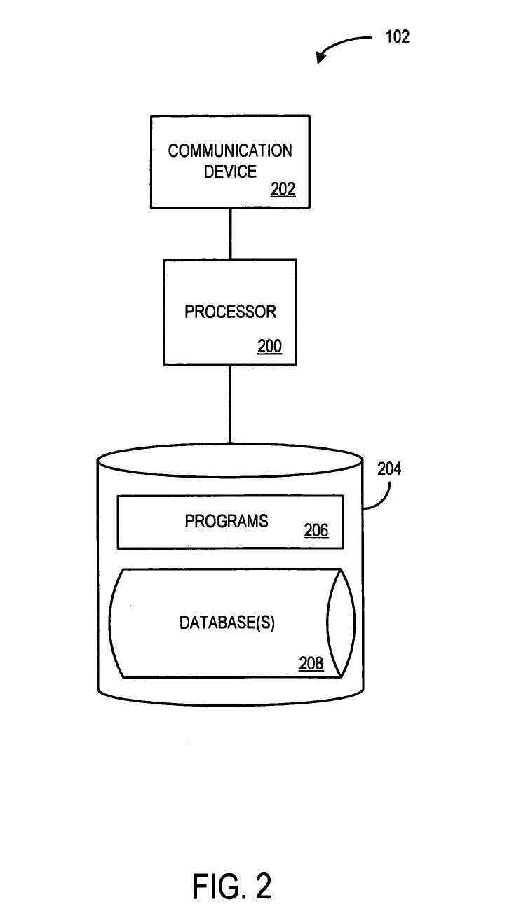

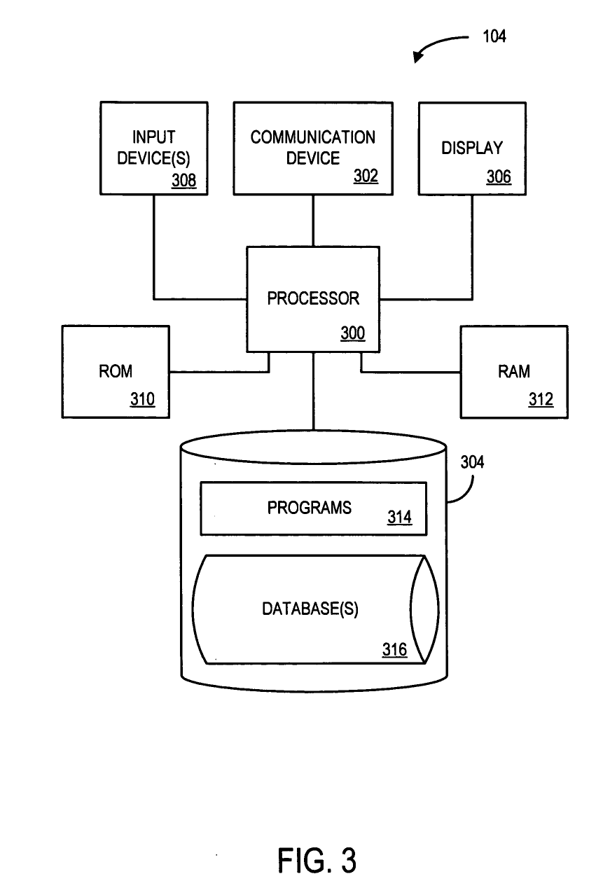

Each of the devices of system 100 may be formed of devices capable of performing the various functions described herein. Exemplary embodiments of the order processing server 102 and of a user device 104 will be described below with reference to FIGS. 2 and 3, respectively.

A securities exchange 106 may include any computing device(s) operated by or on behalf of one or more securities exchanges. Each of the securities exchanges may be in communication with other devices described herein, such as the order processing server 102 and the securities quotation sources 108, using techniques known in the art. Each exchange device 106 may include one or more operator terminals allowing specialists or traders at the exchange to respond to securities trading orders received and to complete an order pursuant to its terms.

A currency market 110 may include any computing device(s) or network(s) of devices operated to provide a foreign exchange market. Each currency market may be in communication with other devices described herein, such as the order processing server 102 and the foreign exchange quotations sources 112, using techniques known in the art.

The devices described herein (e.g., order processing server 102, user devices 104, securities exchanges 106, quotation sources 108, 112, currency markets 110) may communicate, for example, via one or more communication networks. For example, some or all of the devices may be in communication via an Internet Protocol (IP) network such as the Internet. Some or all of the devices may be in communication via other types of networks, such as an intranet, a Local Area Network (LAN), a Metropolitan Area Network (MAN), a Wide Area Network (WAN), a proprietary network, a Public Switched Telephone Network (PSTN), and/or a wireless network.

According to some embodiments of the present invention, communication between some or all of the devices of the trading system 100 may be via a temporary computer communication channel (e.g., a logic path through which information can be exchanged). In other words, the communication channel between various devices may be established and discontinued as appropriate. For example, order processing server 102 may exchange information with a user device 104a via a Web site (e.g., when a browser application executing on the user device 104a is accessing the Web site to place a securities trading request).

According to some embodiments, some or all of the devices may communicate with other devices via a public computer communication network. That is, at least a portion of the communication network may be accessed by devices other than the devices depicted in FIG. 1. Note, however, that the information exchanged between order processing server 102 and other devices of FIG. 1 may be encrypted or otherwise protected to prevent a third party from accessing, manipulating, understanding and/or misusing the information. In some embodiments, some or all of the devices may communicate over a private network.

In other embodiments, the devices of FIG. 1 are connected differently than as shown. For example, some or all of the devices may be connected indirectly to one another (e.g., via the Internet). Of course, embodiments of the invention may include devices that are different from those shown. It should also be noted that although the devices are shown in communication with each other, the devices need not be constantly exchanging data. Rather, communication may be established when necessary and severed at other times or always available but rarely used to transmit data. Moreover, although the illustrated communication links appear dedicated, it should be noted that each of the links may be shared by other devices.

Reference is now made to FIG. 2 where an embodiment of order processing server 102 is shown. As depicted, order processing server 102 includes a computer processor 200 operatively coupled to a communication device 202 and a storage device 204.

Processor 200 may be constituted by one or more conventional processors, and may, for example, comprise RISC-based and other types of processors. Processor 200 operates to execute processor-executable process steps so as to control the elements of order processing server 102 to provide desired functionality.

Communication device 202 may be used to communicate, for example, with other devices (such as user devices 104, securities exchanges 106 and sources 108 of securities quotations, currency markets 110 and sources 112 of foreign exchange quotations). Communication device 202 is therefore preferably configured with hardware suitable to physically interface with desired external devices and/or network connections. For example, communication device 202 may comprise an Ethernet connection to a local area network through which order processing server 102 may receive and transmit information over the World Wide Web.

Storage device 204 may comprise any appropriate information storage device, including combinations of magnetic storage devices (e.g., magnetic tape and hard disk drives), optical storage devices such as CDs and/or DVDs, and/or semiconductor memory devices such as Random Access Memory (RAM) devices and Read Only Memory (ROM) devices.

Storage device 204 stores one or more programs 206 for controlling processor 200. The programs 206 comprise processor-executable process steps of order processing server 102, and may include process steps that constitute processes provided in accordance with principles of the present invention to implement a foreign securities trading method described below. Processor 200 performs instructions of programs 206, and thereby operates in accordance with the present invention. In some embodiments, programs 206 may be configured, at least in part, as a neural network or other type of program using techniques known to those skilled in the art to achieve the functionality described herein. Among the functions implemented via the programs 206 may be host server functions and order processing and execution functions.

Any or all process steps of order processing server 102 may be read from a computer-readable medium, such as a floppy disk, a CD-ROM, a DVD-ROM, a Zip™ disk, a magnetic tape, or a signal encoding the process steps, and then stored in storage device 204 in a compressed, uncompiled and/or encrypted format. Processor-executable process steps being executed by processor 200 may typically be stored temporarily in RAM (not separately shown) and executed therefrom by processor 200. In alternative embodiments, hard-wired circuitry may be used in place of, or in combination with, processor-executable process steps for implementation of processes according to embodiments of the present invention. Thus, embodiments of the present invention are not limited to any specific combination of hardware and software.

Storage device 204 may also store databases 208, including, for example, a database containing current market conditions in the securities exchanges 106 (including, e.g., current quotations for securities traded on the securities exchanges 106), and a database containing current foreign exchange market conditions. Other databases may also be provided (e.g., order and execution data may also be stored in the storage device 204).

There may also be stored in storage device 204 other unshown elements that may be necessary for operation of order processing server 102, such as an operating system, a database management system, other applications, other data files, and “device drivers” for allowing processor 200 to interface with devices in communication with communication device 202. These elements are known to those skilled in the art, and are therefore not described in detail herein.

Although not shown in the drawing, the order processing server 102 may also include one or more input and/or output devices to permit a system administrator or other user to provide input to the processor 200 or to receive output from the processor 200.

Reference is now made to FIG. 3, where an embodiment of a user device 104 is shown. As depicted, user device 104 includes a processor 300 operatively coupled to a communication device 302, a storage device 304, a display 306, one or more input devices 308, ROM 310 and RAM 312. Some or all of the hardware constituting the user device 104 may be conventional personal computer (PC) hardware. Thus the processor 300 may be a conventional Pentium® processor, for example, and the communication device 302 may be a conventional communication port which enables the user device 104 to exchange data with the order processing server 102 via, e.g., an Ethernet connection. The storage device 304 may include a conventional hard disk drive or other mass storage device. The display 306 may be a conventional CRT or flat panel computer monitor. The display 306 has a screen (not separately shown) by which price quotation information may be displayed to the user in accordance with principles of the present invention. Other information, including elements of a user interface, may also be presented to the user via the display 306.

The input devices 308 may include a conventional keyboard and/or a conventional pointing device such as a mouse or trackball. ROM 310 may store basic input/output instructions and instructions used during boot-up of user device 104. RAM 312 provides fast data storage and retrieval and thus may function as working memory for processor 300. In addition, RAM 312 may temporarily store instructions corresponding to processor-executable process steps being executed by processor 300.

Storage device 304 stores one or more programs 314 for controlling processor 300. The programs comprise processor-executable process steps of user device 104, and may include process steps that cause the user device 104 to interact with the order processing server to provide functionality in accordance with principles of the present invention, as described in more detail below. Processor 300 performs instructions of programs 314, and thereby may operate in accordance with the present invention. The programs 314 may include, for example, a conventional operating system such as the Windows operating system, as well as device drivers and a client side application that enables the user device 104 to interact with order processing server 102 and to display via display 306 quotation information and/or other information downloaded from order processing server 102. Software to implement functions in accordance with the invention may, in some embodiments, be distributed between the user device 104 and the order processing server 102.

Storage device 304 may also store one or more databases 316, which may, for example, store data downloaded from the order processing server 102. This data may include, for example, data concerning current securities and/or foreign exchange market conditions.

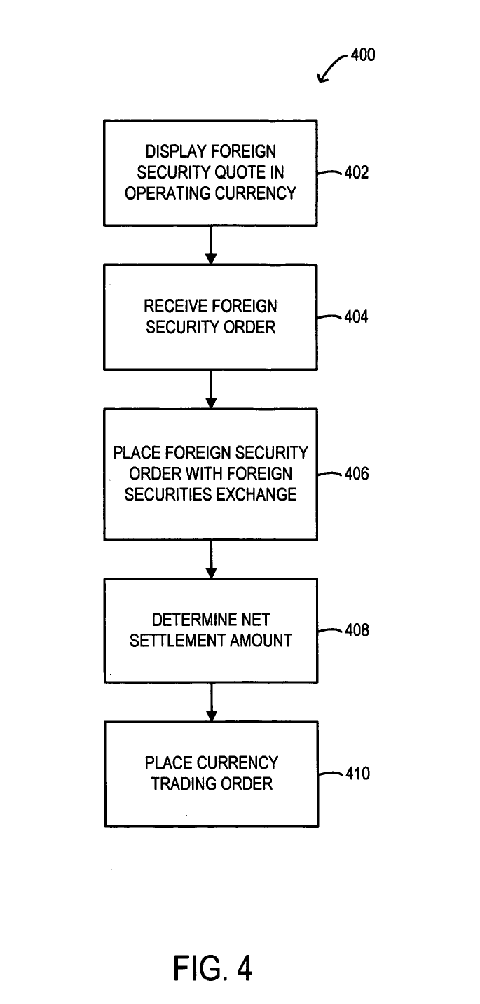

Operation of some embodiments of the present invention will now be described by referring to FIG. 4 where a process 400 is shown for handling a securities trading order pursuant to one embodiment of the present invention. The flow chart in FIG. 4 and the flow charts in other figures described herein do not imply a fixed order to the steps, and embodiments of the present invention can be practiced in any order that is practicable.

Process 400 begins at 402 where the trading system 100 displays via a display 306 (FIG. 3) of a user device 104 price quotation information concerning a security that is of interest to the user of the user device 104. The security may be a foreign security, such that the security is traded on a securities exchange 110 which may operate in a local currency that is different from the operating currency preferred by the user. The price quotation information may be presented in the user's operating currency, rather than in the local currency of the securities exchange on which the security is traded.

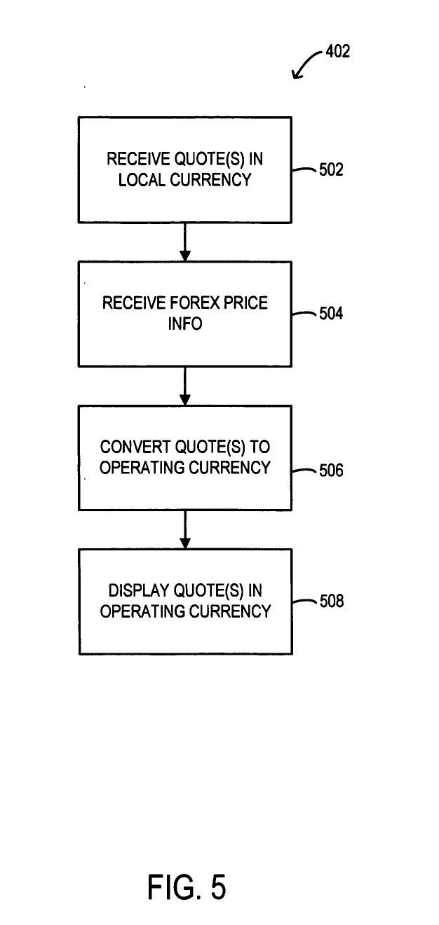

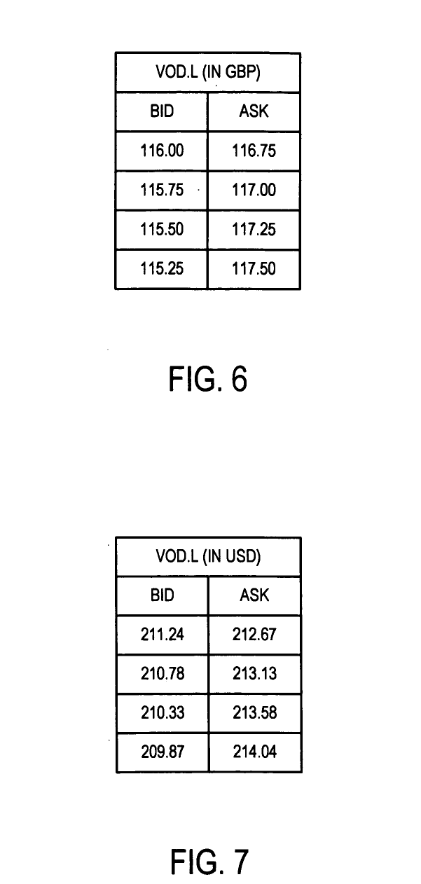

Details of step 402 are illustrated in FIG. 5. Step 402 may begin at 502, where the order processing server 102 receives from a securities quotation source 108 quotation information for the security in question, with the quotation information being denominated in the local currency of the securities exchange on which the security trades. FIG. 6 is a table that shows example price quotation information of the type that may be received at 502. In the example shown in FIG. 6, the price quotation information is for Vodafone common stock traded in pounds sterling (GBP) on the London Stock Exchange. In the example shown in FIG. 6, both bid and ask quotation information is provided, and the quotation information provides an indication of the current state of the specialist's order book for Vodaphone.

Step 402 continues at 504, where the order processing server 102 receives from foreign exchange quotation source 112 foreign exchange quotation (exchange rate) information for the local currency in question. In this case it is assumed that the user's operating currency is U.S. dollars (USD), and that the exchange rate information shows an exchange rate between U.S. dollars and pounds sterling. The exchange rate information received at 504 may include bid and ask quotes.

Step 402 continues at 506, where the order processing server 102 converts the local currency quotation information for the security in question to quotation information denominated in the user's operating currency. For example, the local currency bid quotation for the security may be converted using the foreign exchange bid rate between the local and operating currencies; and the local currency ask quotation for the security may be converted using the foreign exchange ask rate between the local and operating currencies. FIG. 7 shows the security quotation information of FIG. 6, converted to the user's operating currency, which is assumed to be U.S. dollars. In this example, it is assumed that the bid quotes in FIG. 7 are obtained by multiplying the bid quotes in FIG. 6 by a foreign exchange bid rate, assumed to be 1.8210 USD per GBP; and it is assumed that the ask quotes in FIG. 7 are obtained by multiplying the ask quotes in FIG. 6 by a foreign exchange ask rate, assumed to be 1.8216 USD per GBP. In some embodiments, the conversion rates represent forward pricing as of an expected settlement date for a securities trading transaction executed at the present time.

Step 402 continues at 508, where the user device 104 displays on the display 306 the operating currency security price quotation information generated at 506. An example of such operating currency security price quotation information is shown, as noted above, in FIG. 7.

Referring again to FIG. 4, the process 400 advances to 404 where a securities trading order for a foreign security is received. In some embodiments, the order may be submitted as user input directly from a user device 102 to order processing server 102. Orders may be submitted in batch files (e.g., with multiple trade requests) or individually. Each order may include details of the order, including: an identification of the customer, an identification of the security to be purchased or sold, and the size of the order. Other terms may also be provided (e.g., such as an identification of whether the order is a market or limit order or the like). In the case of a limit order, additional information may be provided, such as the limit price.

The process 400 then advances to 406, where the order processing server 102 places a trading order for the foreign security in question with the securities exchange on which the security trades. The order is placed in accordance with the order received from the user device at 404. In the event that the order is a limit order, the limit price indicated at 404 in the user's operating currency may be translated to the local currency of the securities exchange in accordance with the foreign exchange rate information received at 504 (FIG. 5).

It is assumed that the securities trading order placed at 406 is filled at the securities exchange to which it was directed, and that a confirmation to that effect is sent from the securities exchange to the order processing server 102. It is also assumed that the confirmation indicates the price at which the order was filled. Based on this information the order processing server 102 determines a net settlement amount for the transaction, which may reflect settlement fees, commissions, etc. as well as the amount payable for or realized from the transaction. In some embodiments, the calculations required to provide the net settlement amount may be made at the securities exchange or elsewhere other than at the order processing server 102. Accordingly, “determining” the net settlement amount may include simply receiving the net settlement amount from another device. Alternatively, “determining” the net settlement amount may include receiving a confirmation that a securities trading order has been filled, including the price at which the transaction occurred, and then adding or subtracting fees, commissions, etc, as appropriate. In some cases the net settlement amount is simply the amount of the transaction as executed on the exchange, with other fees/commissions payable separately in the user's operating currency. In any case, the determining of the net settlement amount by the order processing server 102 is indicated at 408 in FIG. 4.

In response to the determination of the net settlement amount, the process 400 advances to 410, where the order processing server 102 automatically, and without further input from the user beyond the original placement of the securities order at 404, places a foreign exchange order with a currency market 110 to convert the net settlement amount to the user's operating currency. For example, where the underlying securities trading order was for the purchase of a security, the automatically placed foreign exchange trading order may be to buy forward the local currency as of the date of settlement (typically three days after execution) for the securities trading order. Alternatively, the foreign exchange trading order may be a purchase of the local currency on the spot market. In some embodiments, the foreign exchange order may be placed by the server 102 immediately after the net settlement amount is determined.

As another example, if the underlying securities trading order was for the sale of a security, the automatically placed foreign exchange trading order may be to sell forward the local currency as of the settlement date for the securities trading order, or alternatively the foreign exchange trading order may be a sale of the local currency on the spot market.

With price quotations for a foreign security displayed to the user in the user's operating currency (instead of the local currency in which the security trades), and a foreign exchange order automatically placed by the system to convert the local currency net settlement amount to the user's operating currency, the system effectively presents foreign securities trading to the user in exactly the same manner as trading in domestic securities, and no action is required of the user for foreign securities trading other than as is required for trading domestic securities. Thus it can be said that with the present invention, trading in foreign securities becomes seamless and transparent.

Furthermore, with the foreign exchange order placed as a forward transaction immediately upon determination of the net settlement amount for the securities trade, the user may effectively be shielded from a timing risk with respect to the local currency. As a result, the outcome of the transaction in the user's operating currency essentially mirrors the result to be expected from the operating currency quotation information for the foreign security available to the user at the time the trading decision is made.

In some embodiments, the user interface of the user device 104, in cooperation with the order processing server 102, may present one or more screen displays (not shown) to the user, to permit the user to select in advance for his or her operation of the user device options as to whether foreign securities quotations are to be provided in an operating currency designated by the user or in the local currencies in which the foreign securities trade. Similarly, the system may present the user with advance options as to whether or not the system should automatically place a foreign exchange trading order indicated at 410 in FIG. 4 in response to execution of each foreign securities trading order. In some embodiments, a screen display (not shown) which allows the user to place the foreign securities trading order may also present to the user an option to override a previously indicated preference for an automatic follow-up foreign exchange trading order to fund the foreign securities trading order.

To further illustrate embodiments of the invention, there will now be provided a particular example of how the trading system 100 may handle a foreign securities trading order.

Assume that a user is based in New York and operates in U.S. dollars. Further assume that the user has opted for automatic conversion of quotes of securities prices in local currencies to his/her operating currency and for automatic foreign exchange trading to convert local currency settlements to his/her operating currency. In addition, it will be assumed that the user is interested in trading in Vodaphone common stock, traded on the London Stock Exchange. FIG. 7 shows an example of USD-denominated price quotations for Vodaphone displayed to the user by the trading system (via the display device of the user device 104), whereas FIG. 6 shows the GBP-denominated price quotation information from which the order processing server 102 derived the FIG. 7 information, in the manner described in connection with FIG. 5.

Next assume that the user submits to the order processing server 102, via his/her user device 104, an order to buy 100 shares of Vodaphone at the market. The order processing system responds by placing a corresponding order with the London Stock Exchange. Assuming that the order is executed in London at the current ask price of £116.75, the total price for the transaction is £11,675. For the purposes of the present example, settlement fees and so forth will be disregarded, and the amount of £11,675 will accordingly be taken to be the net settlement amount. A confirmation indicating this amount is received by the order processing server 102 shortly after execution of the trade. It will be assumed that the exchange rules call for settlement three days after execution. Accordingly, the order processing server 102 responds to receiving the confirmation by automatically buying £11,675 forward three days. Assuming that the current three day forward ask price for GBP is 1.8216 USD, the price for the foreign exchange transaction is $21,267.18. In at least some cases, the foreign exchange trading order is placed later the same day that the securities trading order was placed and executed, perhaps immediately after confirmation of execution.

The result of these transactions (disregarding any other positions the user may have) is that as of the settlement day (assumed to be three days after the day the securities trading order was placed and executed), the user will be long Vodaphone common (100 shares, denominated in GBP), flat GBP, and short USD $21,267.18. Consequently, the transaction from the user's point of view is equivalent to buying 100 shares of Vodaphone at the ask price of $212.67 indicated in the quote information of FIG. 7, and the transaction takes place from the user's point of view in essentially the same manner as a purchase of a domestic security. Thanks to the automatic foreign exchange transaction generated by the trading system in accordance with the invention, the user has effectively settled the foreign securities transaction in USD, the user's operating currency, and has been substantially shielded from currency risk.

In the above example, it has been assumed that the user is trading for his/her own account, but it will be recognized that the user may alternatively be a broker executing a foreign securities trading transaction on behalf of a customer.

It has been indicated above in connection with some embodiments that the foreign exchange trading order placed in response to the net settlement amount for the securities trading order may be placed immediately after the net settlement amount is determined. However, in alternative embodiments, a foreign exchange trading order to convert the net settlement amount to the ordering party's operating currency may be placed as part of a batch of foreign exchange trading orders. The batch of foreign exchange trading orders may include foreign exchange trading orders to convert the net settlement amounts for other securities trading orders placed on the same day as the securities trading order in question. The batch of foreign exchange trading orders may, for example, be placed at the end of the trading day on which the securities trading order was placed, or may be placed on the next trading day. The batch of foreign exchange trading orders may be placed by the order processing server 102 automatically, or the placement of the batch of foreign exchange trading orders may be initiated by a user, who may be different from the user who placed the securities trading order.

Although the present invention has been described with respect to a preferred embodiment thereof, those skilled in the art will note that various substitutions may be made to those embodiments described herein without departing from the spirit and scope of the present invention.

What is claimed is:

1. A method comprising:
placing a securities trading order on a securities exchange;
determining a net settlement amount for said securities trading order in a local currency of said securities exchange; and
in response to the determined net settlement amount, automatically placing a foreign exchange trading order to convert the determined net settlement amount from the local currency to an operating currency of a party for whom the securities trading order was placed.

2. The method of claim 1, wherein:
the securities trading order is an order to buy a security; and
the foreign exchange trading order is to buy forward the local currency as of a settlement date for the securities trading order.

3. The method of claim 1, wherein:
the securities trading order is an order to buy a security; and
the foreign exchange trading order is to buy the local currency on a spot market.

4. The method of claim 1, wherein:
the securities trading order is an order to sell a security; and
the foreign exchange trading order is to sell forward the local currency as of a settlement date for the securities trading order.

5. The method of claim 1, wherein:
the securities trading order is an order to sell a security; and
the foreign exchange trading order is to sell the local currency on a spot market.

6. The method of claim 1, wherein the foreign exchange trading order is placed prior to a settlement date for the securities trading order.

7. A method of operating a securities trading system, the system including a user interface, the user interface including a display unit, the method comprising:
receiving initial input from a user to direct the securities trading system to place on a securities exchange a securities trading order for purchase or sale of a security;
in response to said initial input, placing the securities trading order on the securities exchange;
determining a net settlement amount for said securities trading order in a local currency of said securities exchange; and
in response to said determined net settlement amount and without any input from the user after said initial input, automatically placing a foreign exchange trading order to convert the determined net settlement amount from the local currency to an operating currency of a party for whom the securities trading order was placed.

8. The method of claim 7, further comprising:
prior to said receiving step:
receiving quotation information regarding at least one price for said security on said securities exchange;
converting the received quotation information from said local currency to said operating currency; and
displaying on said display unit said converted quotation information.

9. The method of claim 8, wherein said step of converting the received quotation information is based on a forward price for said local currency.

10. The method of claim 7, wherein:
the securities trading order is an order to buy a security; and
the foreign exchange trading order is to buy forward the local currency as of a settlement date for the securities trading order.

11. The method of claim 7, wherein:
the securities trading order is an order to buy a security; and
the foreign exchange trading order is to buy the local currency on a spot market.

12. The method of claim 7, wherein:
the securities trading order is an order to sell a security; and
the foreign exchange trading order is to sell forward the local currency as of a settlement date for the securities trading order.

13. The method of claim 7, wherein:
the securities trading order is an order to sell a security; and
the foreign exchange trading order is to sell the local currency on a spot market.

14. The method of claim 7, wherein the foreign exchange trading order is placed prior to a settlement date for the securities trading order.

15. An apparatus comprising:
a processor; and
a storage device in communication with said processor and storing instructions adapted to be executed by said processor to:
place a securities trading order on a securities exchange;
determine a net settlement amount for said securities trading order in a local currency of said securities exchange; and
in response to the determined net settlement amount, automatically place a foreign exchange trading order to convert the determined net settlement amount from the local currency to an operating currency of a party for whom the securities trading order was placed.

16. An apparatus comprising:
a processor;
an input device in communication with the processor for a user to provide input to the processor;
a display unit controlled by the processor; and
a storage device in communication with said processor and storing instructions adapted to be executed by said processor to:
receive via the input device initial input from the user to direct the apparatus to place on a securities exchange a securities trading order for purchase or sale of a security;
respond to said initial input by communicating with the securities exchange to place the securities trading order on the securities exchange;
determine a net settlement amount for said securities trading order in a local currency of said securities exchange; and
respond to the determined net settlement amount, automatically and without any input from the user after said initial input, by placing a foreign exchange trading order to convert the determined net settlement amount from the local currency to an operating currency of a party for whom the securities trading order was placed.

17. The apparatus of claim 16, wherein the storage device further stores instructions adapted to be executed by the processor to:
prior to receiving the initial input:
receive quotation information regarding at least one price for said security on said securities exchange;
convert the received quotation information from said local currency to said operating currency; and
display on said display unit said converted quotation information.

18. The apparatus of claim 17, wherein the storage device further stores instructions adapted to be executed by the processor to:
convert the received quotation information based on a forward price for said local currency.

19. A medium storing instructions adapted to be executed by a processor to perform a method, said method comprising:
placing a securities trading order on a securities exchange;
determining a net settlement amount for said securities trading order in a local currency of said securities exchange; and
in response to the determined net settlement amount, automatically placing a foreign exchange trading order to convert the determined net settlement amount from the local currency to an operating currency of a party for whom the securities trading order was placed.

20. A medium storing instructions adapted to be executed by a processor to perform a method of operating a securities trading system, the method comprising:
receiving initial input from a user to direct the securities trading system to place on a securities exchange a securities trading order for purchase or sale of a security;
in response to said initial input, placing the securities trading order on the securities exchange;
determining a net settlement amount for said securities trading order in a local currency of said securities exchange; and
in response to said determined net settlement amount and without any user input after said initial input, automatically placing a foreign exchange trading order to convert the determined net settlement amount from the local currency to an operating currency of a party for whom the securities trading order was placed.

21. The medium of claim 20, wherein the instructions are further adapted to be executed by the processor to perform:
prior to said receiving step:
receiving quotation information regarding at least one price for said security on said securities exchange;
converting the received quotation information from said local currency to said operating currency; and
displaying on a display unit said converted quotation information.

22. The medium of claim 21, wherein the instructions are further adapted to be executed by the processor to perform the step of converting the received quotation information based on a forward price for said local currency.

23. An apparatus comprising:
means for placing a securities trading order on a securities exchange;
means for determining a net settlement amount for said securities trading order in a local currency of said securities exchange; and
means for automatically placing a foreign exchange trading order, in response to the determined net settlement amount, to convert the determined net settlement amount from the local currency to an operating currency of a party for whom the securities trading order was placed.

24. An apparatus comprising:
means for receiving initial input from a user to direct the apparatus to place on a securities exchange a securities trading order for purchase or sale of a security;
means for responding to said initial input by placing the securities trading order on the securities exchange;
means for determining a net settlement amount for said securities trading order in a local currency of said securities exchange; and
means for responding to said determined net settlement amount, automatically and without any user input after said initial input, by placing a foreign exchange trading order to convert the determined net settlement amount from the local currency to an operating currency of a party for whom the securities trading order was placed.

25. The apparatus of claim 24, further comprising:
means for receiving, prior to said initial input, quotation information regarding at least one price for said security on said securities exchange;
means for converting prior to said initial input the received quotation information from said local currency to said operating currency; and
means for displaying said converted quotation information to the user prior to said initial input.

26. The apparatus of claim 25, wherein said means for converting the received quotation information converts the received quotation information based on a forward price for said local currency.

27. A method comprising:
placing a securities trading order on a securities exchange;
determining a net settlement amount for said securities trading order in a local currency of said securities exchange; and
placing a foreign exchange trading order to convert the determined net settlement amount from the local currency to an operating currency of a party for whom the securities trading order was placed, the foreign exchange trading order being placed as part of a batch of foreign exchange trading orders.

28. The method of claim 27, wherein the batch of foreign exchange trading orders is placed at an end of a trading day on which the securities trading order was placed.

29. The method of claim 27, wherein the batch of foreign exchange trading orders is placed on a trading day that immediately follows a trading day on which the securities trading order was placed.

30. The method of claim 27, wherein the batch of foreign exchange trading orders is placed without input from a user who placed the securities trading order.

31. The method of claim 30, wherein the batch of foreign exchange trading orders is placed automatically and without input from any user.

32. The method of claim 27, wherein:
the securities trading order is an order to buy a security; and
the foreign exchange trading order is to buy forward the local currency as of a settlement date for the securities trading order.

33. The method of claim 27, wherein:
the securities trading order is an order to buy a security; and
the foreign exchange trading order is to buy the local currency on a spot market.

34. The method of claim 27, wherein:
the securities trading order is an order to sell a security; and
the foreign exchange trading order is to sell forward the local currency as of a settlement date for the securities trading order.

35. The method of claim 37, wherein:
the securities trading order is an order to sell a security; and
the foreign exchange trading order is to sell the local currency on a spot market.

36. An apparatus comprising:
a processor; and
a storage device in communication with said processor and storing instructions adapted to be executed by said processor to:
place a securities trading order on a securities exchange;
determine a net settlement amount for said securities trading order in a local currency of said securities exchange; and
place a foreign exchange trading order to convert the determined net settlement amount from the local currency to an operating currency of a party for whom the securities trading order was placed, the foreign exchange trading order being placed as part of a batch of foreign exchange trading orders.

37. A medium storing instructions adapted to be executed by a processor to perform a method, said method comprising:
placing a securities trading order on a securities exchange;
determining a net settlement amount for said securities trading order in a local currency of said securities exchange; and
placing a foreign exchange trading order to convert the determined net settlement amount from the local currency to an operating currency of a party for whom the securities trading order was placed, the foreign exchange trading order being placed as part of a batch of foreign exchange trading orders.
